(19) United States
(12) Patent Application Publication
(10) Pub. No.: US 2025/0238830 A1
(43) Pub. Date: Jul. 24, 2025

(54) MACHINE LEARNING TECHNIQUES FOR GENERATING RECOMMENDATIONS FOR A TRANSACTION WITHOUT LOSS DATA

(71) Applicant: PROS, INC., Houston, TX (US)

(72) Inventors: Jonas Rauch, Mannheim (DE); Mohit Mahajan, Westford, MA (US); Zijian Zeng, Houston, TX (US); Manu Chaudhary, Houston, TX (US)

(21) Appl. No.: 18/419,168

(22) Filed: Jan. 22, 2024

(51) Int. Cl. G06Q 30/0201

(52) U.S. Cl. CPC G06Q 30/0206

(57) ABSTRACT

Techniques for generating a predicted win rate curve without using loss data are disclosed. An example method includes receiving historical transaction data comprising a plurality of transactions, each transaction comprising a plurality of attributes. The method also includes processing the historical transaction data to generate training data comprising features extracted from the plurality of attributes. The method also includes training, by a processing device, a logistic model using the training data and a predicted price. Training the logistic model includes providing the predicted price and a subset of the features at an input layer of a neural network and training the neural network to generate a mapping from the predicted price and the subset of the features to parameters of a predicted win rate curve generated at an output layer of the neural network.

### TECHNICAL FIELD

Aspects of the present disclosure relate to machine learning techniques for generating recommendations for a transaction based on historical transaction data. Specific aspects relate to machine learning techniques for training a logistic model without using loss data.

### BACKGROUND

Optimization may be pertinent to many aspects of the operation of an organization. For instance, an organization may desire to optimize gross revenue, net revenue, profit, sales volume, etc. These goals change from time to time, as circumstances suggest, and may apply to the entire organization, a subdivision of the overall organization such as a subsidiary, a division, a department, a product line, individual products, etc. These same goals may be directed toward particular customer segments based on demographic data, or other geographic, income, age, or other distinctions in the customer population.

Organizations involved in negotiated transactions may be able to maximize profit over time by developing an optimized pricing strategy. This may involve generating pricing recommendations for negotiated transactions based on historical transaction data. Accurate pricing recommendations may help the organizations to develop a pricing strategy that provides a more optimal balance between profit margin and the rate of success for winning contracts. Optimizing prices in this way can help the organization to maximize profit over time.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example system in accordance with some embodiments of the present disclosure.

FIG. 2 is a block diagram of an example of a logistic model trainer in accordance with some embodiments of the present disclosure.

FIG. 3 illustrates an example process performed by the training module in accordance with some embodiments of the present disclosure.

FIG. 4 is a block diagram of a request handler in accordance with some embodiments of the present disclosure.

FIG. 5 is a graph showing an example of the pricing information that may be displayed to the client in a pricing report in accordance with some embodiments of the present disclosure.

FIG. 6 is a graph showing another example of the pricing information that may be displayed to the client in a pricing report in accordance with some embodiments of the present disclosure.

FIG. 7 is a process flow diagram summarizing a method of generating a win rate curve without loss data in accordance with some embodiments of the present disclosure.

FIG. 8 illustrates a diagrammatic representation of a machine in the example form of a computer system within which a set of instructions, for causing the machine to perform any one or more of the methodologies discussed herein, may be executed.

### DETAILED DESCRIPTION

The present disclosure relates to machine-learning techniques for generating pricing recommendations for negotiated transactions using historical transaction data. Such pricing recommendations may be generated through the analysis of historical transaction data in attempt to estimate a close to optimal price for a future transaction. Conventional systems for generating pricing recommendations usually divide historical transaction data into customer segments (e.g., geographic regions, customer annual revenue buckets) and product segments (e.g., product groups, product lifecycle status, product quality, etc.). This type of data segmentation can be used to partition the large set of a company's transactions into much smaller sets of transactions, each of which can be assumed to be homogenous (e.g., same or similar product, product features, geography, etc.). Each segment can then be analyzed for pricing differences within that smaller partitioned data set to identify opportunities for better pricing.

However, partitioning data into smaller segments and analyzing these segments separately can lead to data sparsity. Sparsely populated segments may present a poor the signal-to-noise ratio which could lead to misleading results, inaccurate predictions, and poor pricing recommendations. To protect against the negative effects of data sparsity, the partitioning process may be limited so that the data is partitioned over a limited number of data features. Limiting the number of features reduces the probability that the segmented set of transactions will not be homogenous. Therefore, the downstream processes that assume homogeneity can have problems with accuracy and making pricing recommendations that are appropriate for that negotiation.

Additionally, if segments are analyzed separately, the information in one segment may not be able to inform the analysis of a different segment. This may lead to missed opportunities to detect pricing effects that may be happening at a more macro level across segments, such as seasonality effects or longer-term market trends.

In addition to specific price recommendations, it may be desirable to understand the price elasticity relevant to a particular transaction (the specific customer, product, etc.). For example, if the client has confidence in the customer relationship or the skill of the salesperson or team conducting the negotiation, the client may decide that a higher price is justifiable. The degree to which the client is willing to deviate from the price recommendation may depend on the price elasticity, which can be characterized using a win rate curve. The win rate curve provides an estimate for the probability of winning a particular transaction over a range of prices. Additionally, the win rate curve in combination with client's cost for the product or service involved in the transaction can be used to generate an expected profit curve that indicates a more optimal price for improving profit over a number of transactions.

Pricing system can generate win rate curves using models that estimate win rates based on historical transaction data that records wins and losses. A win indicates that the transaction was executed, i.e., the customer purchased the product, while a loss indicates that the transaction was not executed, i.e., the customer did not purchase the product. However, such loss data is often not available. For example, many clients may only keep records of transactions that were executed.

Embodiments of the present disclosure address the above-noted and other deficiencies by providing a system that uses improved modeling techniques to generate pricing recommendations without the use of data segmentation and without loss data. In accordance with embodiments described herein, a logistic model may be generated by training an artificial intelligence model or other type of machine learning model such as an artificial neural network. The logistic model may be trained on a body of training data derived from a large corpus of transaction data. Because the training data is not segmented (for example, to focus in on a particular product, geography, or customer), data sparsity on the pricing model is avoided, leading to more reliable and accurate results. Additionally, the trained logistic model can be applied to various types of pricing requests regardless of the product, product features, geography, etc. Because the data used to train the model is not segmented, win rate predictions generated by the logistic model may better reflect broader purchasing insights such that win rate predictions may include influences attributable to other product types, other geographical regions, other customers, and the like, that would not normally be present within the same segment. Moreover, the techniques disclosed herein enable the logistic model to be trained without the use of loss data.

The pricing recommendations and win rate curve generated by the system may be used to develop a collection of pricing information that can help clients to identify more effective offer prices to use in negotiated transactions. The pricing information may be presented to the client in the form of a pricing report, which may include a customer predicted price, a market price, win rate curve, profit margin curve, target price, floor price, expert price, and additional information.

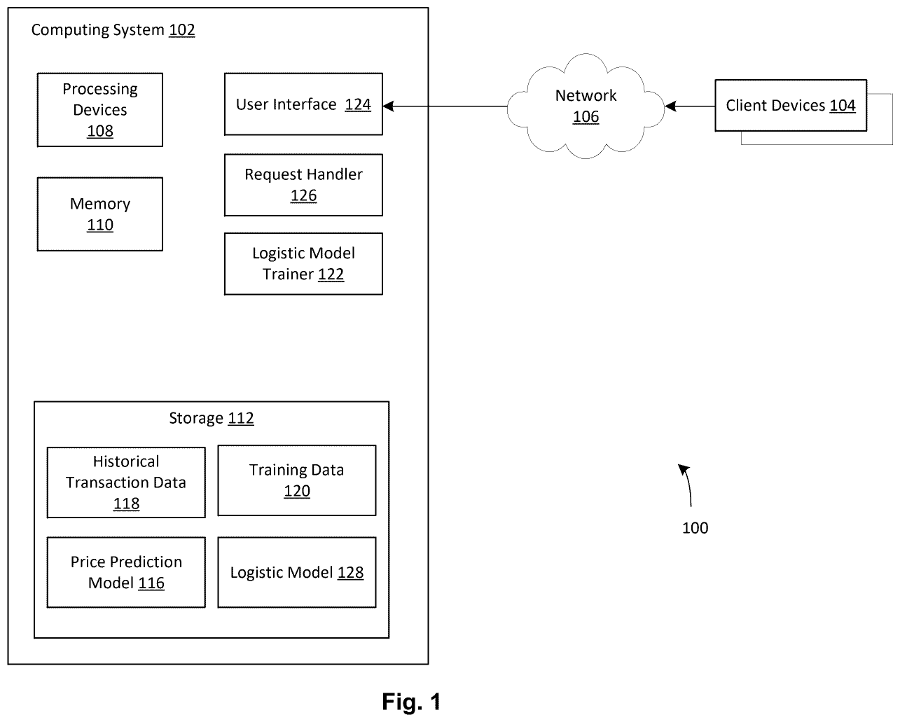

FIG. 1 is a block diagram of an example system 100 in accordance with some embodiments of the present disclosure. One skilled in the art will appreciate that other architectures are possible for system 100 and any components thereof, and that the implementation of a system utilizing examples of the disclosure are not necessarily limited to the specific architecture depicted by FIG. 1. The system 100 may include a computing system 102, which may be coupled to client devices 104 through a network 106. The computing system 102 may be a cloud-based infrastructure configured, for example, as Software as a Service (SaaS) or Platform as a Service (PaaS). In some embodiments, the computing system 102 may be distributed computing system with multiple compute nodes and memory nodes that can be scaled to serve a particular service or application in response to changing workload conditions. The computing system 102 may also be a non-cloud-based system such as a personal computer, a server, one or more servers communicatively coupled through a network, and other configurations.

Each client device 104 may be any suitable type of computing device or machine that has a programmable processor including, for example, server computers, desktop computers, laptop computers, tablet computers, smartphones, etc. In some examples, each of the client devices 104 may include a single machine or multiple interconnected machines (e.g., multiple servers configured in a cluster).

The network 106 may be a public network such as the Internet, a private network such as a local area network (LAN) or wide area network (WAN)), and combinations thereof. In some embodiments, the network 106 may include a wired and/or wireless infrastructures provided by one or more wireless communications systems, such as a WiFi hotspot connected with the network 106 and/or a wireless carrier system that can be implemented using various data processing equipment, communication towers (e.g. cell towers), etc. In some embodiments, the network 106 may be an L3 network. The network 106 may carry communications (e.g., data, message, packets, frames, etc.) between the computing system 100 and the client devices 104.

The computing system 102 can include one or more processing devices 108, memory 110, and storage 112 used to implement the techniques described herein. The processing devices may include central processing units (CPUs), graphical processing units (GPUs), application specific integrated circuits (ASICs), and other types of processors. The memory 110 serves as the main memory or working memory used by the processing devices 108 to store data and computational results. The memory 110 may include volatile memory devices such as random-access memory (RAM), non-volatile memory devices such as flash memory, and other types of memory devices. In certain implementations, main memory 110 may be non-uniform access (NUMA), such that memory access time depends on the memory location relative to processing device 108. Storage 112 may a persistent (e.g., non-volatile) storage device or system and may include one or more magnetic hard disk drives, Peripheral Component Interconnect (PCI) solid state drives, Redundant Array of Independent Disks (RAID) systems, a network attached storage (NAS) array, and others. The storage device 112 may be configured for long-term storage of data and programming used to implement the techniques described herein. It will be appreciated that the processing device 108, memory 110, storage 112 may each represent a monolithic/single device or a distributed set of devices. For example, the processing devices 108, memory 110, and/or storage 112 may each include a plurality of units (e.g., multiple compute nodes, multiple memory nodes, and/or multiple storage nodes) networked together within a scalable distributed computing system. Additionally, the computing system 102 may have additional hardware components not shown in FIG. 1. The client devices 104 may include similar architectures.

The computing system 102 may be configured to store historical transaction data 118. The historical transaction data 118 may include past sales transactions between sellers and purchasers. The transactions may include a variety of data related to any number of transactions between any number of sellers and purchasers. As used herein, the term “client” refers to the seller of a product (e.g., a physical good or service) who is using the system 100 to, for example, receive a pricing recommendation for a potential future transaction or identify a pricing strategy for a product. The term “customer” refers to the purchaser or potential purchaser. At least some of the transactions may relate to a good or service purchased in a negotiated transaction or competitive bidding process between the sellers and purchasers. The historical transaction data 118 may also record transactions relating to a wide variety of products, services, industries, geographical areas, companies, customers, clients, etc. The historical transaction data 118 may include several years of transaction data. Each transaction may be represented by a plurality of attributes, including continuous numerical attributes (e.g., quantities, prices, and dates, etc.) and categorical attributes (geography, customer ID, product ID, product type, etc.).

Each entry in the historical transaction data 118 may include a set of attributes that capture information relevant to that particular transaction. For example, each entry may include product attributes related to the product involved in the transaction, such as a product identifier, stock keeping unit (SKU), product name, brand, color, version, manufacturer's suggested retail price, optional product features such as size, product specifications, and the others. Each entry may also include customer attributes related to the customer involved in the transaction such as a customer business name, customer ID, industry, geographical region in which the customer does business, company size, customer age (e.g., years in business), and others. Each entry may also include transaction attributes related to the transaction itself, such as the date or time of the transaction, a transaction ID, purchase price, product volume (e.g., number of units sold), delivery details (e.g., means, date, location). Each entry may also include the cost, which represents the sum of costs incurred by the client from selling the product or service to the customer (cost of materials, manufacturing, labor, etc.). This can be zero in case selling the product does not cause any marginal cost. Any number of additional details may be included.

In some embodiments, the historical transaction data 118 may only record transactions that were successfully executed. In some embodiments, the historical transaction data 118 may also record entries for transactions that are identified as having not been executed (due to losing a bid, for example). The historical transaction data 118 may be stored in the form of one or more databases (e.g., relational database) within storage 112. The historical transaction data 118 may be communicated to the computing system 102 from the client devices 104 and may be regularly updated to ensure that the data is accurate and current.

The computing system 102 may include a price prediction model 116. The price predictions model 116 may be any suitable type of artificial intelligence model, machine learning model, artificial neural network, and the like. The price prediction model 116 may be trained to generate a customer-specific price prediction and a market price prediction based on the attributes of a transaction. The customer-specific price is a price that is specific to the customer identified in the transaction, and the market price is a price that is customer agnostic and applicable to the market generally. Although a single price prediction model 116 is shown, the price prediction model 116 may include a pair of price prediction models. For example, the price prediction model 116 may include a customer-specific price prediction model trained to predict the customer-specific price, and a market price model trained to predict the market price. Techniques for training the price prediction model 116 are outside the scope of the present disclosure.

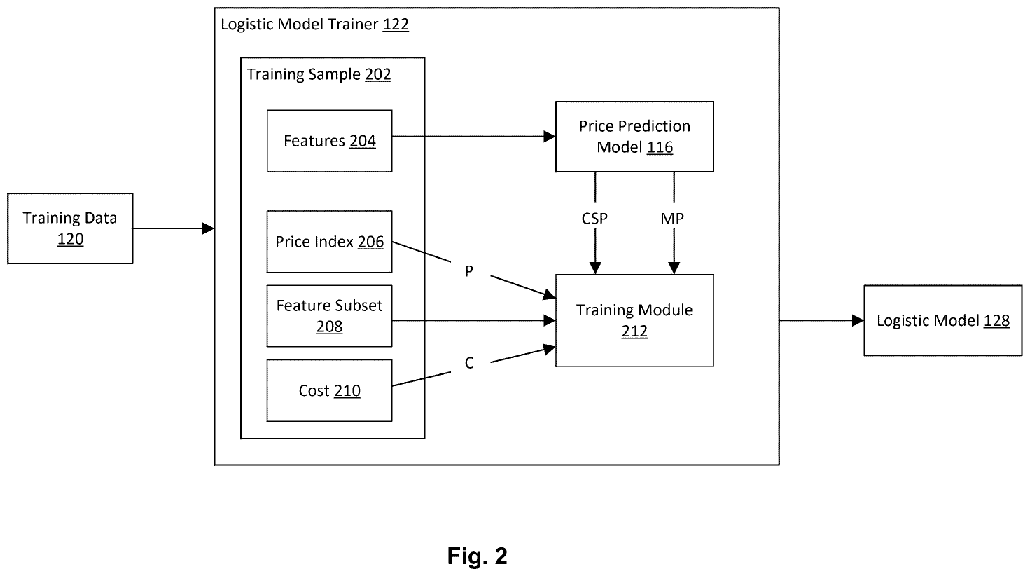

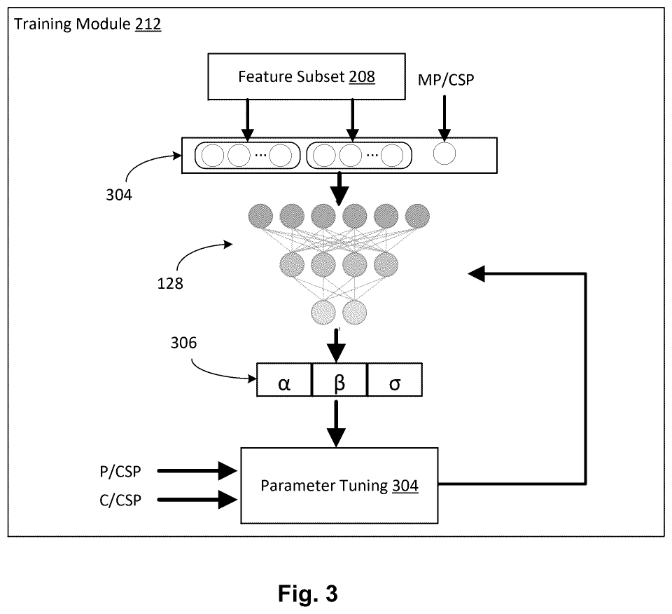

The historical transaction data 118 is processed to generate a set of training data 120 used to generate the trained logistic model 128. The logistic model 128 may be any suitable type of artificial intelligence model, machine learning model, artificial neural network, and the like. Additionally, price predictions output by the price prediction model 116 are input to the logistic model trainer 122 and used as additional training data for training the logistic model 122. A more detailed example of a logistic model trainer 122 in accordance with embodiments is shown in FIGS. 2 and 3.

In some embodiments, the price prediction model 116 and the logistic model 128 may be trained at the same time using the same historical transaction data 118. In other embodiments, the price prediction model 116 may be trained separately prior to training the logistic model 128.

The generation of training data 120 may include processing the historical transaction data 118 to clean and validate the data prior to use. Additionally, categorical data may be converted to a numerical vector representation, referred to herein as a vector embedding. Generating the training data 120 may also include generating derived attributes from the historical transaction data 118, including trend attributes, seasonality attributes, and others. Example techniques for generating the training data 120 are described further in relation to FIG. 2.

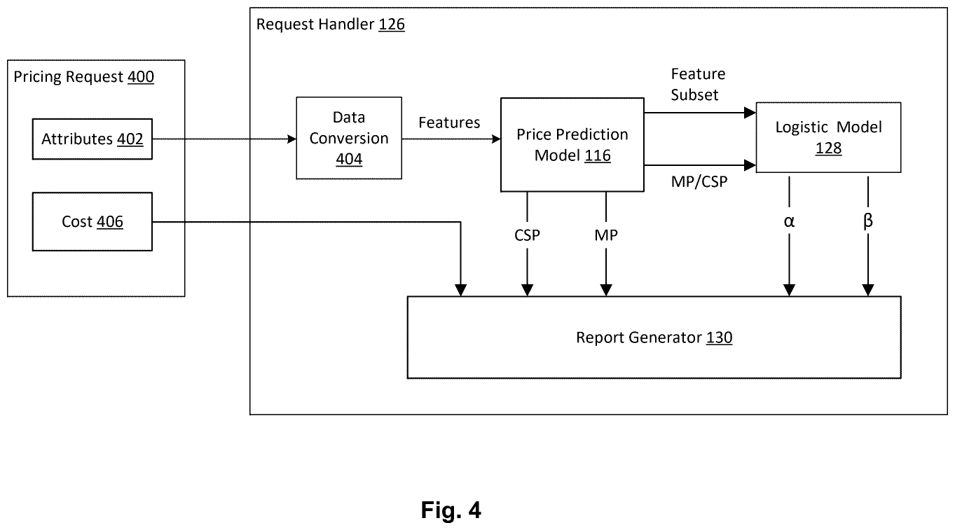

The price prediction model 116 and the trained logistic model 128 may be used to process pricing requests received from the client devices 104. Pricing requests may be received through the user interface 124, which may be a Web server, Application Programming Interface (API), and others. A pricing request may include various information relevant to a potential future transaction, such as a product identifier, product feature information, product cost, number of units to be purchased, transaction date, customer identifier, and others. Pricing requests may be passed to a request handler 126, which is configured to generate pricing recommendations using the price prediction model 116 and the logistic model 128. As explained further in relation to FIG. 4, the attributes included in the pricing request and the price predictions generated by the price prediction model 116 may be input to the logistic model 128 to generate a win rate curve relevant to the transaction described by the pricing request.

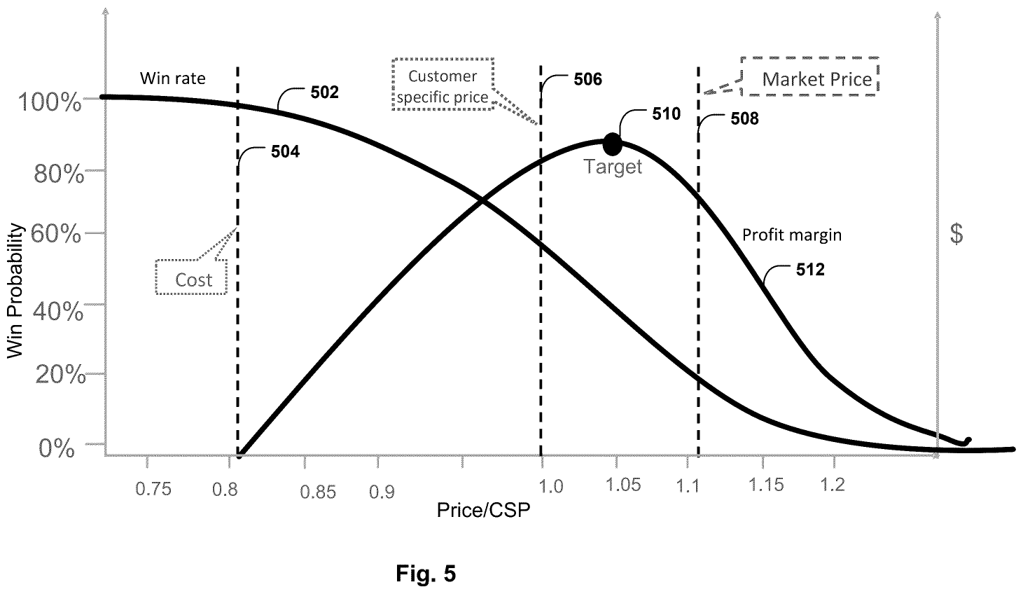

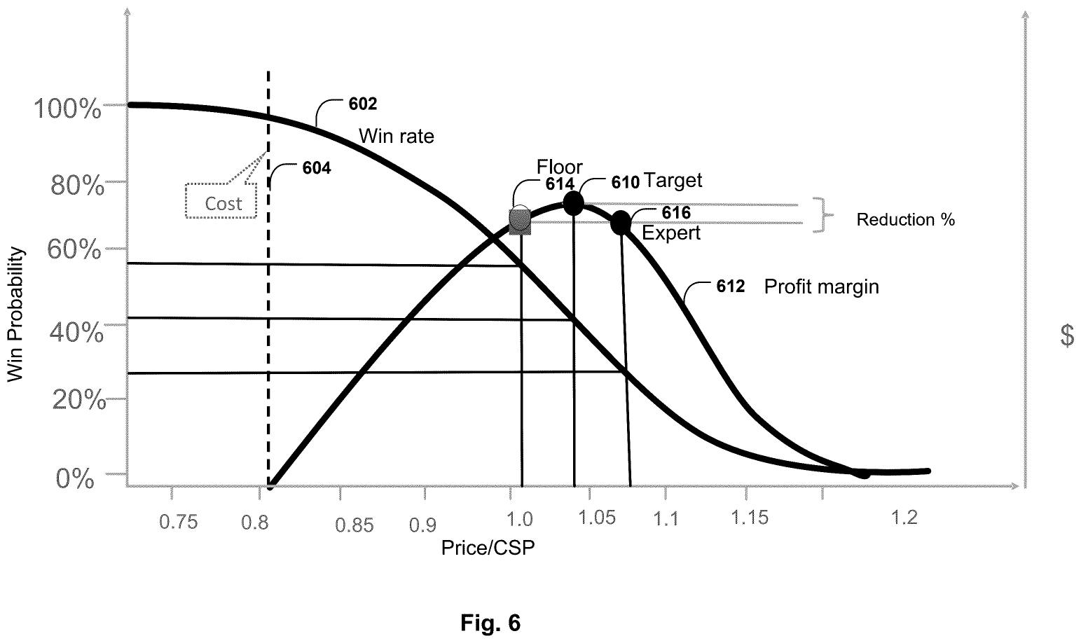

In response to the pricing request, the client may receive a pricing report that can include the price predictions returned by the price prediction model 116, the win rate curve, and additional information which may be computed using the predicted prices and win rate curve, such as a profit margin curve, target price, and others. Pricing information may be presented in the form of a graph, examples of which are shown in FIGS. 5 and 6. The pricing report may be returned to the client device 104 through the user interface 124 or through another route such as a shared storage device, email delivery, and others. Techniques for processing client pricing requests are described further in relation to FIG. 4.

The training data 120 may be updated as new transaction data is received and added to the historical transaction data 118. For example, the client may report additional transactions periodically or in real time new transactions are performed. The training data 120 may be periodically retrieved by the model trainer 122, which uses the updated training data 120 to update the logistic model 128. In this way, the logistic model 128 can be updated over time, for example, weekly, monthly, quarterly, etc. It will be appreciated that various alterations may be made to the system 100 and that some components may be omitted or added without departing from the scope of the disclosure.

FIG. 2 is a block diagram of an example of a logistic model trainer 122 in accordance with some embodiments of the present disclosure. As described above, the logistic model trainer 122 obtains the training data 120 and uses the training data 120 to train the logistic model 128. The logistic model trainer 122 may be implemented in hardware or a combination of hardware a software and any suitable type of computing architecture including distributed computing systems.

To generate the training data 120, the historical transaction data 118 (FIG. 1) may be cleaned and validated prior to use. For example, the historical transaction data 118 may be processed to correct or eliminate data that appears to be in error, such as statistical outliers or misspellings, for example. Additionally, some attributes may be reformatted to a consistent format (e.g., same date format, same monetary unit, etc.).

The historical transaction data 118 may also be processed to generate additional attributes referred to herein as derived attributes. Derived attributes may include customer annual spend, customer growth, trend and seasonality attributes, customer product centricity, customer purchase frequency, customer revenue (overall and per product), and other metrics such as price/price index, margin percent, and others.

The cleaned and prepared data may then be processed to extract features 204 from the data to be used as training data 120. Each feature 204 may be a numerical representation that is generated from one or more of the attributes. The features 204 may include continuous features, categorical features, trend features, and seasonality features. Continuous features are features that represent continuous numerical attributes such as quantities, prices, and dates (e.g., day of the week, week of the year, etc.). Continuous features may be generated by normalizing continuous attributes to a value within the specified range. Various feature scaling techniques may be used to normalize the data, including min-max normalization, mean normalization, and others.

Categorical features are features that represent categorical attributes such as geography, customer ID, and Product ID. Categorical features may be generated using a vector embedding technique, which is able to convert textual information to a vector representation, i.e., n-dimensional vector with an array of n elements, where each element is a number with a value within a specified range between a minimum and maximum value (e.g., between 0 and 1). In vector embedding, the degree of similarity between any two vectors reflects the degree of similarity between the underlying attributes. Thus, the vector embeddings are able to capture semantic relationships and similarities in the data. For example, vectors generated for the attributes “Dallas” and “Houston” would be expected to be relatively similar compared a vector generated for the attribute “New York.” In this way, similar categorical attributes will tend to produce similar categorical features and have a similar effect on the price prediction model.

As noted above, the price prediction model 116 and the logistic model 128 are generated without segmenting the data used to train the models. Accordingly, the training data 120 used to train the logistic model 128 is not segmented by customer, customer size (e.g., average annual revenue), product type, geography, of any other transaction attribute.

In order to train the logistic model 128 to be generally applicable across a diverse range of transactions, the transaction prices may be scaled to generate a price index 206 for each transaction. In this way, the price information can be represented in a uniform way across a broad range of different transactions. To generate the price index 206, the transaction price may first be converted to a price per unit. The price per unit may then be scaled by dividing the transaction price by a normalizing value, which may vary depending on the business context. In some embodiments, the product's average price is used as the normalizing factor. In this case, the transaction's price per unit would be divided by the product's average price per unit to generate the price index. All other monetary inputs (in particular cost 210) are scaled by the same factor in order to preserve their relative ratios. This way, scaling acts like a currency conversion into a virtual currency specific to the transaction.

The training data 120 may be divided into a number of training samples, each of which corresponds with a specific historical transaction. Some of the training data 120 may be used as testing data, which is used for a validation phase of the training algorithm. The training samples and testing samples may be divided into several batches. FIG. 2 shows a single training sample 202, which includes the features derived from the attributes of a specific transaction and the transaction's corresponding price index. The training process is an iterative process where, at each iteration, a new training sample 202 is obtained and used to partially tune logistic model 128. Accordingly, it will be appreciated that although a single training sample 202 is shown, entire training process will consume multiple training samples over several iterations.

At each iteration of the training process, the features 204 generated for the transaction are input to the price prediction model 116. The features 204 can include a customer ID feature that identifies the customer associated with the transaction from which the training sample is derived. The price prediction model 116 have been trained to output a customer-specific price (CSP) and a market price (MP). The customer-specific price represents an estimate of the price that the particular customer (identified by the customer ID feature) would pay for the transaction described by the features 204 if the historical pricing policy is followed. The market price represents an estimate of the market price for the same transaction if the historical pricing policy is followed. In other words, the market price is customer agnostic and applicable to the market generally.

In some embodiments, feature importance scores may be generated for each of the features 204 input to the price prediction model 116. A feature importance score is a value that indicates which of the features 204 affected the prices output by the model and the relative influence that each feature had on the resulting prices. Feature importance scores may be generated using Shapley values, for example. The feature importance scores may be used to rank the features to identify a feature subset 208, which is a subset of the features 204. The feature subset 208 may include a specified number of the features 204 with the highest feature scores.

The customer-specific price, market price, price index 206, cost 210, and feature subset 208 are all input to the training module 212 and used to train the logistic model as described further in relation to FIG. 3. After this iteration of the training process is complete, a new training sample 202 is obtained, and the process described above is repeated for the new training sample 202.

FIG. 3 illustrates an example process performed by the training module 212 in accordance with some embodiments of the present disclosure. In the embodiment shown in FIG. 3, the logistic model 128 is a neural network. It will be appreciated that the neural network depicted is merely an exemplary illustration and that embodiments of the present techniques are not limited to a neural network with this specific configuration. The logistic model 128 may include any suitable number of input nodes, hidden layers (including zero hidden layers), nodes per layer, etc. The logistic model 128 may also use custom layers and activation functions. For example, to model uncertainty, the logistic model 128 can use custom Variational Inference layers where the model weights are random variables. Additionally, the logistic model 128 may use a custom a non-linear activation function that ensures that the alpha parameter is always negative, as described further below. In the following description, specific techniques for training the logistic model 128 are presented. However, it will be appreciated that the techniques described herein are provided as example implementations and that other techniques may be used to train a model to predict a win rate curve without loss data without deviating from the scope of the present disclosure.

The input to the logistic model 128 includes the feature subset 208 and the market price, which is scaled by the customer-specific price and used as an additional input feature (MP/CSP). The output of the logistic model 128 includes the three values α, β, and σ, where α represents the slope of the win rate curve, β represents the offset of the logistic curve, and σ represents the standard deviation of pricing decisions.

In some embodiments, a suitable activation function is used to ensure that slope a is negative and the standard deviation σ is positive. In particular, assume the last layer outputs three values a, b, and s. Then the following transformation function may be used to obtain α, β, and σ:

$$α - \frac{- 1.}{log ( 1 + {e}^{a} )}$$

$$β = α \cdot b + l$$

$$σ = log ( 1 + {e}^{s} )$$

Here, log(1+e^{x}) is the “Softplus” function which is an activation function that can be used to map real numbers to positive real numbers. The first formula ensures that α<0. The second formula ensures that β scales automatically with α, which makes training more robust. The additive term l is a constant computed as

$$l = log ( \frac{Target Winrate}{1 - Target Winrate} )$$

where the Target Winrate is the same manually defined model parameter that is also used in the Winrate Penalty loss term below. Adding it here ensures that a default model output of b=0 maps to the desired logit value corresponding to the Target Winrate. The third formula ensures that σ is positive.

In some embodiments, the price index 206 and cost 210 are scaled by the customer-specific price. The values α, β, and σ from the logistic model 128, the scaled price index (P/CSP), and the scaled cost index (C/CSP) are input to the parameter tuning module 304, which adjusts the weights and biases of the logistic model 128. The parameter tuning module 304 adjusts the values of the neural network's weights and biases to minimize a loss function that characterizes the difference between the neural network's output and the desired output.

The desired values for α, β, and σ are not directly observed from the historical transaction data due to the lack of loss data. Accordingly, a predicted win distribution is computed based on the assumption sales representative historically are pricing around the optimal rate. Given the parameters α and β and the scaled cost of the transaction, C/CSP, a predicted optimal price, q*, is computed. A predicted offer distribution is computed based on the assumption that the offered prices have a normal distribution with the mean of the normal distribution approximately equal to the optimal price, q*, and a standard deviation, σ. This predicted offer distribution is not observed in the training data set due to the lack of loss data. The predicted win distribution, i.e. the distribution of paid prices in the successful transactions, can be computed by applying the predicted win rate curve to the predicted offer distribution. This predicted win distribution can be compared with the distribution of paid prices in the wins-only historical transaction data to determine how closely the predicted win rate curve matches the desired output. This may be expressed mathematically as shown below.

The probability of a win given quote q is represented by:

$$p ( y = 1 \vert q , α , β ) = \frac{1}{( 1 + {e}^{- α q - β} )}$$

where y is a binary random variable with y=1 representing a win and y=0 representing a loss. The probability of a win given a quote q is modeled using a logistic curve with slope and offset parameters α and β.

Denote by q*(α, β, C/CSP) the optimal scaled quote given parameters α, β and scaled cost C/CSP. This optimal quote is determined as the value that maximizes the expected profit function:

$$profit ( q ) = ( q - \frac{C}{C S P} ) \cdot \frac{1}{( 1 + {e}^{- α q - β} )}$$

where the first term (q−C/CSP) is the scaled profit margin for a successful transaction and the second term

$$\frac{1}{( 1 + {e}^{- α q - β} )}$$

is the predicted win probability at quote q.

Assume that quotes, q, (i.e., the offered prices in all transactions, including the un-observed transactions from offers that did not end up being wins) have a Normal distribution centered around the optimal quote:

q˜N(q*,σ²)

Denote by f (q; q*, σ²) the density function of this Normal distribution evaluated at q.

The scaled prices P/CSP observed in the historical win-only data are only those from offers that ended up being wins. In other words, P/CSP in the training has the distribution of q, given that a win is observed:

$$\frac{P}{C S P} ∼ q \vert y = 1$$

The loss function for the model is the negative log-likelihood of observing q=P/CSP, given that a win is observed and given the predicted parameters α, β, σ. Using Bayes Formula it may be expressed as:

$$\begin{matrix}log p ( q \vert y = 1 , α , β , σ ) = log [ \frac{p ( y = 1 ⋀ q \vert α , β , σ )}{p ( y = 1 \vert a , β , σ )} ] \\ = log [ \frac{p ( y = 1 \vert q , α , β ) p ( q \vert {q}^{*} , σ )}{p ( y = 1 \vert α , β , σ )} ] \\ = log p ( y = 1 \vert q , α , β ) + log p ( q \vert {q}^{*} , σ ) - \\ log p ( y = 1 \vert α , β , σ )\end{matrix}$$

The likelihood loss function is given by:

$$Likelihood Loss = log [ \frac{1}{( 1 + {e}^{- α q - β} )} ] + log [ f ( q ; {q}^{*} , {σ}^{2} ) ] - log [ {\int }_{- ∞}^{∞} \frac{f ( q ; {q}^{*} , {σ}^{2} )}{( 1 + {e}^{- α q - β} )} d q ]$$

In the above loss function, the logistic curve (i.e., win rate curve) is represented by:

$$log [ \frac{1}{( 1 + {e}^{- α q - β} )} ]$$

The normal distribution (i.e., the predicted distribution of offered prices) is represented by:

log[f(q;q*,σ²)]

The overall expected win-rate, i.e. the marginal probability of a win, marginalized over the offered prices q, is represented as the logistic-normal integral:

$$log [ {\int }_{- ∞}^{∞} \frac{f ( q ; {q}^{*} , {σ}^{2} )}{( 1 + {e}^{- α q - β} )} d q ]$$

The logistic-normal integral may be approximated numerically.

In addition, a secondary loss term may be added which regularizes the model by guiding it towards a target win-rate which given as a manually defined model parameter. The win-rate penalty loss is the binary cross-entropy:

$$Winrate Penalty = [ target winrate ] \cdot p ( y = 0 )$$

where again the win rate is given by the logistic normal integral:

$$p ( y = 1 ) = {\int }_{- ∞}^{∞} \frac{f ( q ; {q}^{*} , {σ}^{2} )}{( 1 + {e}^{- α q - β} )} d q$$

The total loss function is the weighted sum:

$$Loss = Likelihood Loss + Penalty Weight \cdot Winrate Penalty$$

Where Penalty Weight is a manually defined hyperparameter.

The parameters α, β, and σ may be updated using a gradient descent technique, wherein gradients of the loss function are computed with respect to the parameters (e.g., weight and biases) of the logistic model 128 that predicts α, β, and σ. The parameters of the logistic model are iteratively adjusted until the logistic model converges on a solution for the current training sample. As described in relation to FIG. 2, the above process may be repeated for multiple training samples 202. Once the logistic model 128 is fully trained on multiple training samples 202, the logistic model 128 will map the features and scaled market price of a potential future transaction to predicted values of α and β that can be used to generate a predicted win rate curve for the transaction.

FIG. 4 is a block diagram of a request handler 126 in accordance with some embodiments of the present disclosure. The request handler 126 may be implemented in hardware or a combination of hardware a software and any suitable type of computing architecture.

The request handler 126 is configured to process pricing requests 400 received from the client devices 104 to generate pricing recommendations using the price prediction model 116 and the trained logistic model 128. The pricing request 400 may include various attributes 402 of a potential future transaction, such as a product identifier, product feature information, number of units to be purchased, transaction date, customer identifier, and others. The pricing request 400 may include a cost 406, which represents the client's cost per unit for the product.

The request attributes 402 are ingested by the data conversion module 404 to generate the input to the price prediction model 116 and the trained logistic model 128. The data conversion module 404 converts the attributes 402 to features using the same feature extraction process described above in relation to FIG. 2. Specifically, continuous attributes are converted to continuous features using the same feature scaling technique, and categorical attributes are converted to categorical features using the same vector embedding technique.

The features generated from the pricing request are then input to the price prediction model 116, which generates a customer-specific price (CSP) and a market price (MP). Additionally, a feature subset is generated by selecting features from the pricing request that correspond with the feature subset used to train the logistic model 128 as described above in relation to FIG. 2. The feature subset and the market price are input to the logistic model 128. As described above, the price information input to the logistic model 128 is scaled by the customer-specific price. Accordingly, the market price is also scaled by the customer specific price output by the price prediction model 116. The resulting output of the logistic model 128 is the predicted values of α and β that can be used to generate a predicted win rate curve for the transaction.

The customer-specific price and market price generated by the price prediction model 116 and the win rate parameters α and β generated by the logistic model 128 may be sent to the report generator 130 along with the cost 406 included in the pricing request. The report generator 130 uses these values to generate the pricing report to be provided to the client in response to the pricing request. The pricing report may include various information, including the predicted customer-specific price, predicted market price, a recommend price target, a win rate curve, the customer's cost per unit, a profit margin curve, recommended floor price, recommended expert price, and others. The computation of this information is described further in relation to FIGS. 5 and 6.

FIG. 5 is a graph showing an example of the pricing information that may be displayed to the client in a pricing report in accordance with some embodiments of the present disclosure. The pricing report may be generated by the report generator 130 as described above. As shown in FIG. 5, the pricing information includes a graph of the win rate curve 502, which can be computed from the win rate parameters received from the logistic model 128 using the follow formula:

$$\frac{1}{( 1 + {e}^{- α - β * p r i c e} )}$$

The win rate curve 502 is a graph of win probability versus price, which indicates an estimated probability of winning the transaction described in the pricing request at a range of price points. In this example, the displayed prices are scaled by the customer-specific price generated by the price prediction model since the output of the models are in the same scale space as the prices used to train the models. In some embodiments, the displayed prices may be rescaled to an actual price denominated in the appropriate currency (e.g., an actual dollar amount) by multiplying the prices received from the models by the customer-specific price. In some embodiments, the prices may be further upscaled using the inverse normalization operation that was used to scale the prices to generate the price index as described in relation to FIG. 2, e.g., multiplying the resulting price index by the average price per unit.

The pricing report may also include a predicted profit margin curve 512, which can be computed form the win rate curve 602, the corresponding price, and the customer cost using the following formula:

$$predicted profit margin = ( price - cost ) \times win rate$$

The pricing report shown in FIG. 5 also shows additional benchmarks, including the customer cost per unit 504, the predicted customer-specific price 506, the predicted market price 508, and a recommended target price 510. As shown in FIG. 5, the recommended target price 510 may be selected as a peak of the profit margin curve 512. The recommended target price 510 is a trade-off between increasing the potential profit for the transaction versus the reduced probability of winning the specific transaction. The recommended target price 510 can be viewed as an estimate of the price that would be expected to maximize the client's profit over time given multiple similar transactions. In this example, the recommended target price 510 is between the customer specific price 506 and the market price 508. However, the recommended target price 510 can also be lower than the customer specific price 506 or higher than the market price 508 depending on various factors such as the customer's cost per unit and/or the relationship between the predicted customer-specific price 506 and the predicted market price 508.

FIG. 6 is a graph showing another example of the pricing information that may be displayed to the client in a pricing report in accordance with some embodiments of the present disclosure. The pricing report of FIG. 6 is similar to the pricing report shown in FIG. 5, and includes a graph of the win rate curve 602, predicted profit margin curve 612, the customer cost per unit 604, the predicted customer-specific price 606, the predicted market price 608, and a recommended target price 610.

The pricing report of FIG. 6 also includes additional benchmarks referred to as a floor price 614 and an expert price 616. The floor price 614 represents a recommended lowest price for the transaction described in the pricing request, and the expert price 616 represents a recommended highest price for the transaction. In some embodiments, the floor price 614 and expert price 616 may be computed by specifying a profit reduction (e.g., percentage reduction) to be applied to the predicted profit margin at the recommended target price (the peak of the profit margin curve) and identifying the two price points along the predicted profit margin curve at the lower profit margin value. The floor price 614 and the expert price 616 can serve as pricing guidelines to help the client negotiate a deal.

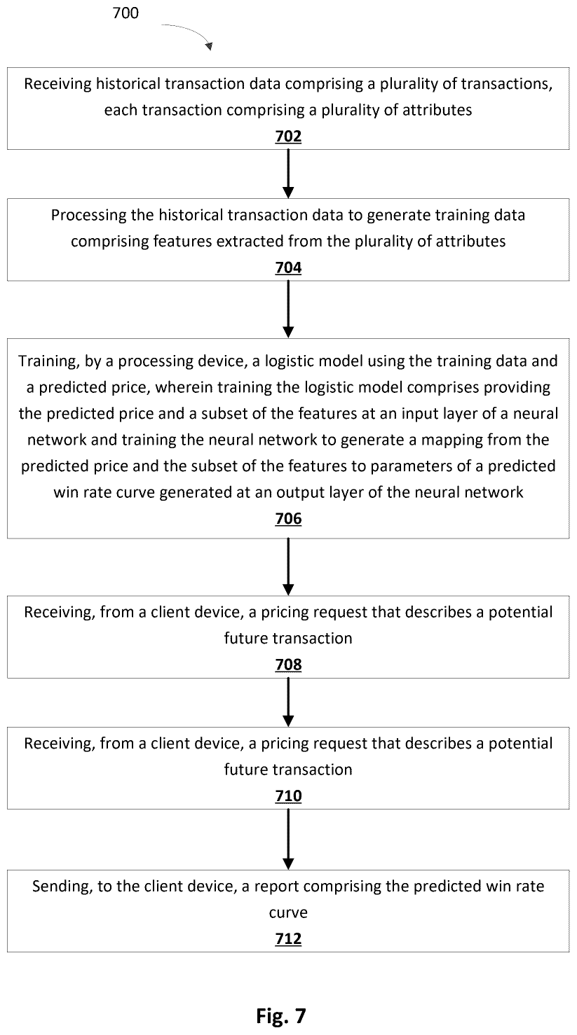

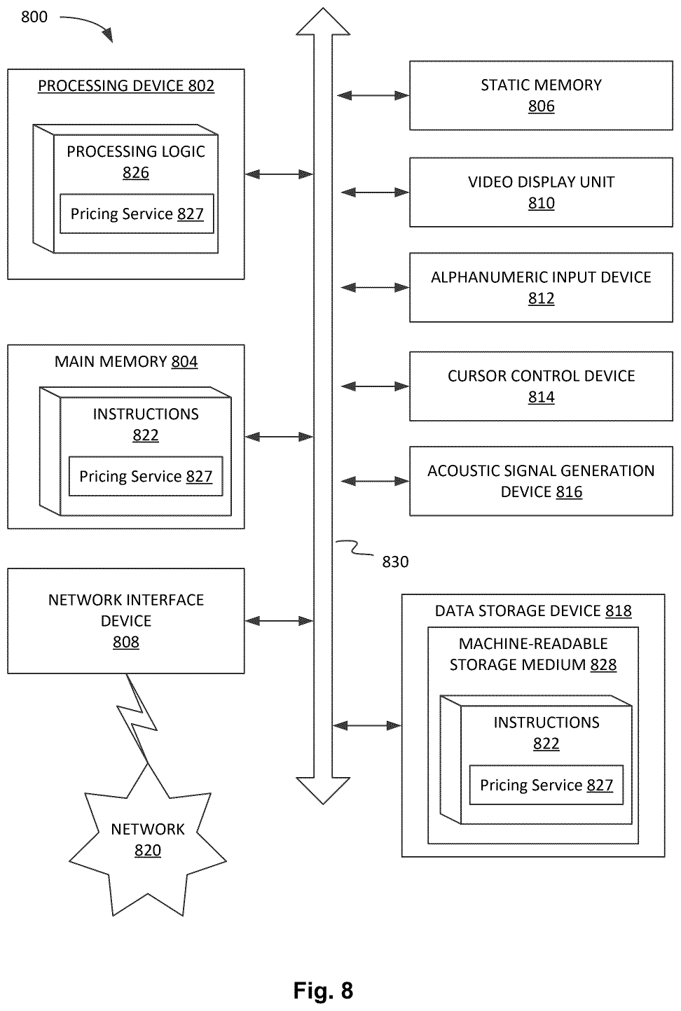

FIG. 7 is a process flow diagram summarizing a method of generating a win rate curve without loss data in accordance with some embodiments of the present disclosure. Method 700 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 700 may be performed by the computing system 102 FIG. 1 or the pricing service 827 shown in FIG. 8. The method may begin at block 702.

At block 702, historical transaction data comprising a plurality of transactions are received, each transaction comprising a plurality of attributes.

At block 704, the historical transaction data is processed to generate training data comprising features extracted from the plurality of attributes.

At block 706, a logistic model is trained using the training data and a predicted price, wherein training the logistic model comprises providing the predicted price and a subset of the features at an input layer of a neural network and training the neural network to generate a mapping from the predicted price and the subset of the features to parameters of a predicted win rate curve generated at an output layer of the neural network.

At block 708, a pricing request that describes a potential future transaction is received from a client device.

At block 710, a predicted win rate curve for the potential future transaction is generated using the trained logistic model.

At block 712, a report comprising the predicted win rate curve is sent to the client device.

It will be appreciated that embodiments of the method 700 may include additional blocks not shown in FIG. 7 and that some of the blocks shown in FIG. 7 may be omitted. Additionally, the processes associated with blocks 702 through 712 may be performed in a different order than what is shown in FIG. 7.

FIG. 8 illustrates a diagrammatic representation of a machine in the example form of a computer system 800 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a web appliance, a server, and other machines capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server, such as a cloud server, configured as a developer platform for building, storing, testing, and distributing software packages.

The exemplary computer system 800 includes a processing device 802, a main memory 804 (e.g., read-only memory (ROM), flash memory, dynamic random access memory (DRAM), a static memory 806 (e.g., flash memory, static random access memory (SRAM), etc.), video display unit 810, alphanumeric input device 812, cursor control device 814, and acoustic signal generation device 816, and a data storage device 818, which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute processing logic 826 for performing the operations and steps discussed herein. For example, the processing logic 826 may include logic and data for performing the functions of a pricing service 827, which may include the logistic model trainer 120, request handler 126, price prediction model 116, logistic model 128, and any of the other components described above in FIGS. 1-4.

The data storage device 818 may include a machine-readable storage medium 828, on which is stored one or more set of instructions 822 (e.g., software) embodying any one or more of the methodologies of functions described herein, including instructions to cause the processing device 802 to perform the functions of the pricing service 827. The instructions 822 may also reside, completely or at least partially, within the main memory 804 or within the processing device 802 during execution thereof by the computer system 800; the main memory 804 and the processing device 802 also constituting machine-readable storage media. The instructions 822 may further be transmitted or received over a network 820 via the network interface device 808.

While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “configuring,” “training,” “identifying,” “transmitting,” “sending,” “storing,” “detecting,” “processing,” “generating” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving historical transaction data comprising a plurality of transactions, each transaction comprising a plurality of attributes;
processing the historical transaction data to generate training data comprising features extracted from the plurality of attributes;
training, by a processing device, a logistic model using the training data and a predicted price, wherein training the logistic model comprises providing the predicted price and a subset of the features at an input layer of a neural network and training the neural network to generate a mapping from the predicted price and the subset of the features to parameters of a predicted win rate curve generated at an output layer of the neural network;
receiving, from a client device, a pricing request that describes a potential future transaction;
generating a predicted win rate curve for the potential future transaction using the trained logistic model; and
sending, to the client device, a report comprising the predicted win rate curve.

2. The method of claim 1, wherein the predicted price is a predicted market price generated by a price prediction model.

3. The method of claim 1, wherein the predicted price is a predicted market price generated by a price prediction model scaled by a customer-specific price generated by the price prediction model.

4. The method of claim 1, wherein the features are input to a price prediction model to generate the predicted price, and wherein the subset of the features is selected from the features based on a feature importance score computed for each of the features.

5. The method of claim 1, wherein the price prediction model and the logistic model are trained concurrently and wherein the features used to train the price prediction model and the logistic model are not segmented by product, product type, geography, or customer size.

6. The method of claim 1, wherein training the neural network comprises minimizing a loss function that characterizes a difference between a predicted price distribution for wins produced from the predicted win-rate curve and an actual price distribution of paid prices in the historical transaction data.

7. The method of claim 1, wherein the predicted win rate curve is generated without the use of loss data that describes failed transactions.

8. The method of claim 1, wherein processing the request comprises converting attributes of the potential future transaction to additional features, inputting the additional features to the price prediction model to generate an additional price prediction, and inputting a subset of the additional features to the trained logistic model to generate the predicted win rate curve.

9. A system comprising:
a memory; and
a processing device, operatively coupled to the memory, the processing device to:
receive historical transaction data comprising a plurality of transactions, each transaction comprising a plurality of attributes;
process the historical transaction data to generate training data comprising features extracted from the plurality of attributes;
train a logistic model using the training data and a predicted price, wherein to train the logistic model comprises to provide the predicted price and a subset of the features at an input layer of a neural network and train the neural network to generate a mapping from the predicted price and the subset of the features to parameters of a predicted win rate curve generated at an output layer of the neural network;
receive, from a client device, a pricing request that describes a potential future transaction;
generate a predicted win rate curve for the potential future transaction using the trained logistic model; and
send, to the client device, a report comprising the predicted win rate curve.

10. The system of claim 9, wherein the predicted price is a predicted market price generated by a price prediction model.

11. The system of claim 9, wherein the predicted price is a predicted market price generated by a price prediction model scaled by a customer-specific price generated by the price prediction model.

12. The system of claim 9, wherein the processing device is further to:
input the features to a price prediction model to generate the predicted price; and
select the subset of the features based on a feature importance score computed for each of the features.

13. The system of claim 9, wherein the price prediction model and the logistic model are trained concurrently and wherein the features used to train the price prediction model and the logistic model are not segmented by product, product type, geography, or customer size.

14. The system of claim 9, wherein to train the neural network comprises to minimize a loss function that characterizes a difference between a predicted price distribution for wins produced from the predicted win-rate curve and an actual price distribution of paid prices in the historical transaction data.

15. The system of claim 9, wherein the processing device is to generate the predicted win rate curve without the use of loss data that describes failed transactions.

16. The system of claim 9, wherein to process the request, the processing device is to:
convert attributes of the potential future transaction to additional features;
input the additional features to the price prediction model to generate an additional price prediction; and
input a subset of the additional features to the trained logistic model to generate the predicted win rate curve.

17. A non-transitory computer-readable storage medium including instructions that, when executed by a processing device, cause the processing device to:
receive historical transaction data comprising a plurality of transactions, each transaction comprising a plurality of attributes;
process the historical transaction data to generate training data comprising features extracted from the plurality of attributes;
train a logistic model using the training data and a predicted price, wherein to train the logistic model comprises to provide the predicted price and a subset of the features at an input layer of a neural network and train the neural network to generate a mapping from the predicted price and the subset of the features to parameters of a predicted win rate curve generated at an output layer of the neural network.

18. The non-transitory computer-readable storage medium of claim 17, wherein the price prediction model and the logistic model are trained concurrently and wherein the features used to train the price prediction model and the logistic model are not segmented by product, product type, geography, or customer size.

19. The non-transitory computer-readable storage medium of claim 17, wherein to train the neural network comprises to minimize a loss function that characterizes a difference between a predicted price distribution for wins produced from the predicted win-rate curve and an actual price distribution of paid prices in the historical transaction data.

20. The non-transitory computer-readable storage medium of claim 17, wherein the processing device is to generate the predicted win rate curve without the use of loss data that describes failed transactions.
